(19) United States
(12) Patent Application Publication
(10) Pub. No.: US 2008/0070617 A1
(43) Pub. Date: Mar. 20, 2008

(54) Reset circuit and method of mobile phone

(75) Inventor: Seong-Jun Ban, Gum-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/711,677

(22) Filed: Feb. 28, 2007

(30) Foreign Application Priority Data
Sep. 15, 2006 (KR) 2006-89610

(51) Int. Cl. H04M 1/00

(52) U.S. Cl. 455/550.1

(57) ABSTRACT

A reset circuit and method of a mobile phone is provided for resetting the mobile phone using a hardware reset key when the mobile phone is locked up or operates abnormally. A reset circuit includes a hardware reset signal generator for generating a hardware reset signal in response to an input of a hardware reset key of the mobile phone. A power controller generates a reset signal on the basis of the hardware reset signal and controls a power of the mobile phone according to a power status maintenance signal. A controller is initialized by the reset signal from the power controller, to generate the power status maintenance signal on the basis of a voltage level of the hardware reset signal. A hardware reset signal delay circuit provides the hardware reset signal to the controller after delaying for a predetermined time duration.

### PRIORITY

This application claims the benefit under 35 U.S.C. § 119(a) of a Korean Patent Application filed in the Korean Intellectual Property Office on Sep. 15, 2006 and assigned Serial No. 2006-89610, the entire disclosure of which is hereby incorporated by reference.

### BACKGROUND OF THE INVENTION

1. Field of the Invention

The present invention relates to a mobile phone. More particularly, the present invention relates to a reset circuit and method of a mobile phone.

2. Description of the Related Art

Typically, a mobile phone is provided with a reset function for initializing software. For resetting, a user is required to reboot the mobile phone by pushing a power button or by separating a battery from the mobile phone and then reattaching.

In a case of using the power button, the mobile phone is often inadvertently reset by the user's carelessness. For example, when a bar type mobile phone is carried in a pocket, the power button may be inadvertently pressed such that the mobile phone may be repeatedly reset. In order to solve this problem, the mobile phone is generally implemented with a switch that operates when the power button is pressed for an extended duration.

As the mobile phone becomes slimmer and more compact, some slide and bar type mobile phones employ an undetachable battery such that the battery cannot be separated from the mobile phone. In order to reset such a mobile phone, a hardware reset key (H RESET) is provided. Accordingly, when the mobile phone is locked up or operates abnormally, the hardware reset key is used for resetting the mobile phone. However, the hardware reset key disadvantageously turns off the power.

FIG. 4 is a graph illustrating a reset timing of a conventional power-on button-based reset method, and FIG. 5 is a graph illustrating a reset timing of a conventional battery detachment-based reset method.

Referring to FIG. 4, in order to turn on the mobile phone, a power button of the conventional mobile phone is pressed for predetermined time duration. If the power button is not pressed for a sufficiently long duration, the power-on process is canceled. In FIG. 4, if the power button is pressed, an on-switch signal 4a is output to a controller such that the controller raises a reset signal (RESET) 4b to a high voltage level for resetting the mobile phone. At the same time, the controller drops a voltage maintenance signal (PS HOLD) 4c to a low level while the power button is pushed. Accordingly, if the power button is released before the voltage maintenance signal (PS HOLD) raises and a boot voltage (V1) 4d drops, the power-on process is canceled.

Referring to FIG. 5, the conventional hardware reset key-based reset method drops the on-switch signal 5a to the low level if the hardware reset key is pushed. At the same time, the reset signal (RESET) 5b drops and then rises such that the mobile phone is initialized. In order to reset the mobile phone, pressing of the hardware reset key should be continued for a predetermined time duration. However, if the reset signal 5b disappears during the reset process, the voltage maintenance signal (PS HOLD) 5c drops by force. A boot voltage 5d drops and thereby fails to reboot the mobile phone. Accordingly, there is a need for an improved reset circuit and method for use in a mobile phone.

### SUMMARY OF THE INVENTION

The present invention has been made in an effort to solve at least the above problems, and it is an object of the present invention to provide a reset circuit and method for a mobile phone that are capable of distinctively performing a reset of the mobile phone on the basis of key input.

It is another object of the present invention to provide a reset circuit and method for a mobile phone that are capable of performing a hardware reset with a special key input.

It is another object of the present invention to provide a reset circuit and method for a mobile phone that are capable of performing a hardware reset without detaching a battery of the mobile when the mobile phone is locked up or operates abnormally.

In accordance with an aspect of the present invention, the above and other objects are accomplished by a reset circuit of a mobile phone. The reset circuit includes a hardware reset signal generator for generating a hardware reset signal in response to an input of a hardware reset key of the mobile phone. A power controller generates a reset signal on the basis of the hardware reset signal and controlling a power of the mobile phone according to a power status maintenance signal. A controller is initialized by the reset signal from the power controller, to generate the power status maintenance signal on the basis of a voltage level of the hardware reset signal. A hardware reset signal delay circuit provides the hardware reset signal to the controller after delaying for a predetermined time duration.

Preferably, the hardware reset signal generator includes a transistor for outputting the hardware reset signal to the hardware reset signal delay circuit and then to the power controller.

Preferably, the reset circuit further includes a power supply status detector for detecting an abnormal power supply to the hardware reset signal generator.

Preferably, the power supply status detector includes a power status detection unit for detecting an abnormal power status of the mobile phone; and an OR gate for providing an output of the power status detection unit to the hardware reset signal generator.

Preferably, the hardware reset signal delay circuit can adjust a reboot time by adjusting the delay time duration of the hardware reset signal.

In accordance with another aspect of the present invention, the above and other objects are accomplished by a reset method for a mobile phone. The reset method includes inputting a reset signal for initializing the mobile phone; initializing the mobile phone on the basis of the reset signal; determining whether the reset signal is generated by a power on/off key or by a hardware reset key; and maintaining power status of the mobile phone if the reset signal is triggered by the hardware reset key.

Preferably, the reset method further includes maintaining power status of the mobile phone if the reset signal is generated by the power on/off key and the power on/off key is pressed for a predetermined time duration; and turning the power off if the reset signal is generated by the power on/off key and the power on/off key is pressed for less than the predetermined time duration.

In accordance with another aspect of the present invention, the above and other objects are accomplished by a reset circuit of a mobile phone including a hardware reset key, a power on/off key, a controller having a GPIO and generating a power status maintenance signal, and a power controller receiving signal input by the hardware reset key and the power on/off key and the power status maintenance signal from the controller and providing a reset signal to the controller. The reset circuit includes a power status monitor for detecting an abnormal power for operating the mobile phone; a hardware reset signal generator for generating a hardware reset signal on the basis of an output of the power status monitor and the signal input by the hardware reset key; and a hardware reset signal delay circuit for delaying the hardware reset signal for a predetermined time duration.

Preferably, the hardware reset generator includes an NPN type transistor.

Preferably, an input node of the hardware reset signal delay circuit is connected to an output node of the power controller.

### BRIEF DESCRIPTION OF THE DRAWINGS

The above and other objects, features and advantages of the present invention will be more apparent from the following detailed description in conjunction with the accompanying drawings, in which:

FIG. 1 is a circuit diagram illustrating a hardware reset apparatus of a mobile phone according to an exemplary embodiment of the present invention;

FIG. 2 is a flowchart illustrating a power on/off key triggered-reset procedure of a reset method according to an exemplary embodiment of the present invention;

FIG. 3 is a flowchart illustrating a hardware reset key triggered-reset procedure of a reset method according to an exemplary embodiment of the present invention;

FIG. 4 is a graph illustrating a reset timing of a conventional power-on button-based reset method;

FIG. 5 is a graph illustrating a reset timing of a conventional battery detachment-based reset method;

FIG. 6 is a graph illustrating a reset timing of the reset method of FIG. 2; and

FIG. 7 is a graph illustrating a reset timing of the reset method of FIG. 3.

Throughout the drawings, like reference numbers will be understood to refer to like elements, features and structures.

### DETAILED DESCRIPTION OF EXEMPLARY EMBODIMENTS

Exemplary embodiments of the present invention will now be described with reference to the accompanying drawing figures. It should be understood that the following detailed description is intended to be exemplary, and those of ordinary skill in the art will readily appreciate that various changes and modifications to the embodiments described herein may be made without departing from the scope and spirit of the present invention. Also, detailed descriptions of well-known functions and structures incorporated herein are omitted for clarity and conciseness.

The following description assumes a situation in which a battery-powered mobile phone is rebooting after a reset for solving an abnormal operation of the mobile phone. Embodiments of the present invention provide a hardware reset technique for initializing and rebooting a mobile phone equipped with an undetachable battery.

In exemplary embodiments of the present invention, a mobile phone is provided with a hardware reset key for rebooting the mobile phone when the mobile phone is operating in an abnormal manner. If the hardware reset key is pushed, a hardware reset signal is output to a controller through a General Purpose Input/Output (GPIO). The hardware reset signal has a waveform different to that of a power on/off signal generated when pushing a power on/off key. Accordingly, the controller distinguishes the hardware reset signal from the power on/off signal.

The controller of the mobile phone detects a signal input through the GPIO. In an exemplary embodiment, if a voltage level of the detected signal is low, the controller determines that the signal is generated by the hardware reset key and thus maintains a power condition. If the voltage level of the detected signal is high, the controller determines that the signal is generated by the power on/off key and thus maintains the power condition. The power on/off signal is specified with a long key code, such that the controller can recognize the power on/off signal through a long press of the power on/off key.

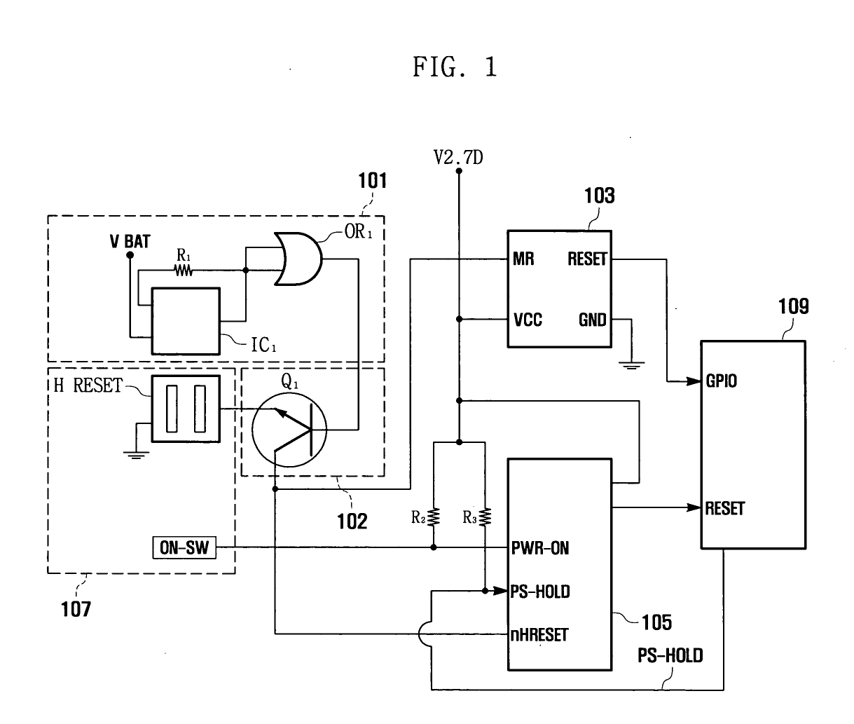

FIG. 1 is a circuit diagram illustrating a hardware reset apparatus of a mobile phone according to an exemplary embodiment of the present invention.

Referring to FIG. 1, the hardware reset apparatus according to an exemplary embodiment of the present invention includes a keypad 107 having a hardware reset key (H RESET) and a power on/off key (ON-SW). A controller 109 initializes the mobile phone in response to a signal input by the hardware reset key (H RESET) or an on/off switch and outputs a power status maintenance signal (PS HOLD) by distinguishing the signal input by the hardware reset key (H RESET) from that input by an on/off switch by a signal input to the GPIO. A power status detector 101 detects a power status, the power status detector 101 including a voltage detection circuit (IC1) and an OR gate (OR1). A hardware reset signal generator 102 generates a hardware reset signal (nHRESET) on the basis of the signal (H RESET) input by the hardware reset key and an output of the power status detector 101. A power controller 105 initializes the controller 109 and controls the power of the mobile phone, in response to a controller reset signal (RESET) generated on the basis of a signal input by the power on/off key (ON-SW), the power status maintenance signal (PS HOLD) and hardware reset signal (nHRESET). A hardware reset delay circuit 103 delays an input of the signal from the hardware reset signal generator 102 to the controller 109 through the GPIO such that the controller 109 can differentiate the power on/off signal from the hardware reset signal.

The resistors R2 and R3 are pull-up resistors for pulling up the power on/off signal or the power status maintenance signal (PS HOLD), and a voltage of V2.7D supplied to a power source node Vcc of the hardware reset delay circuit 103 is generated at the power controller 105.

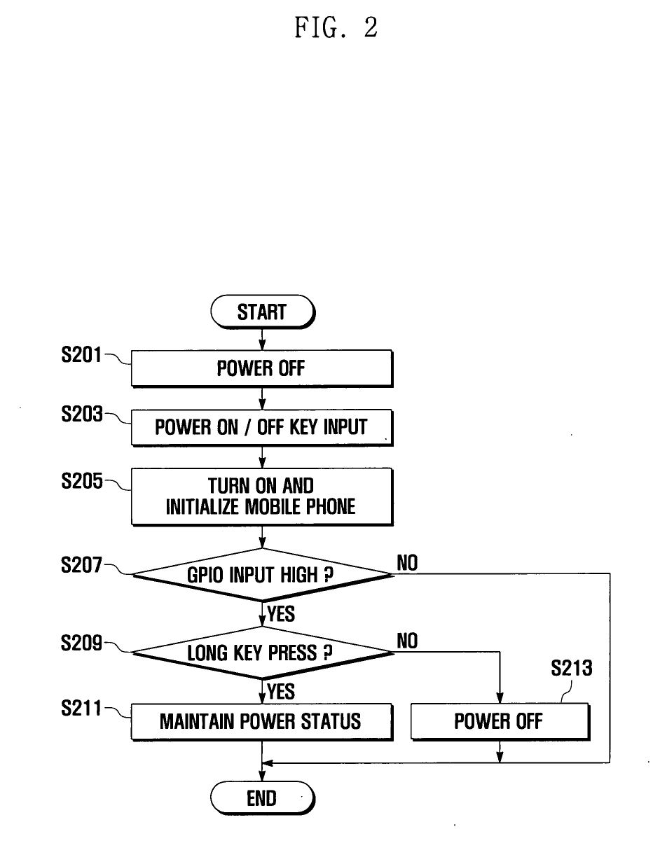

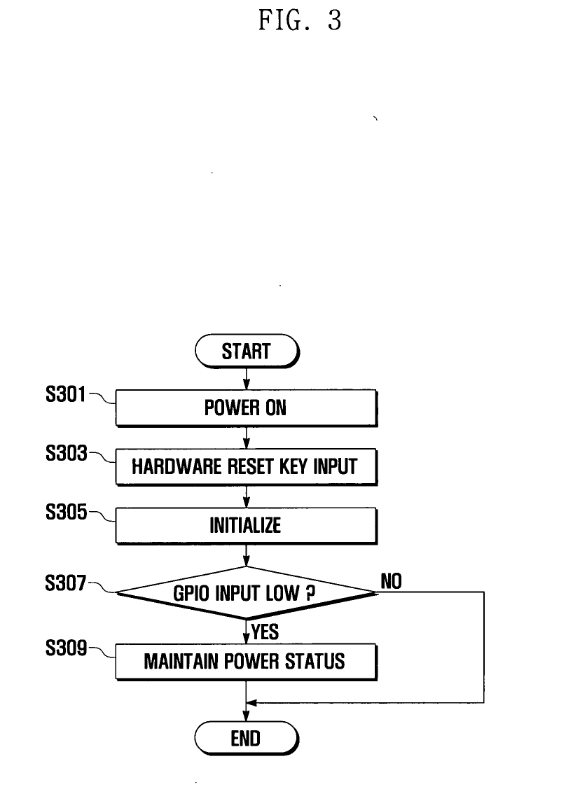

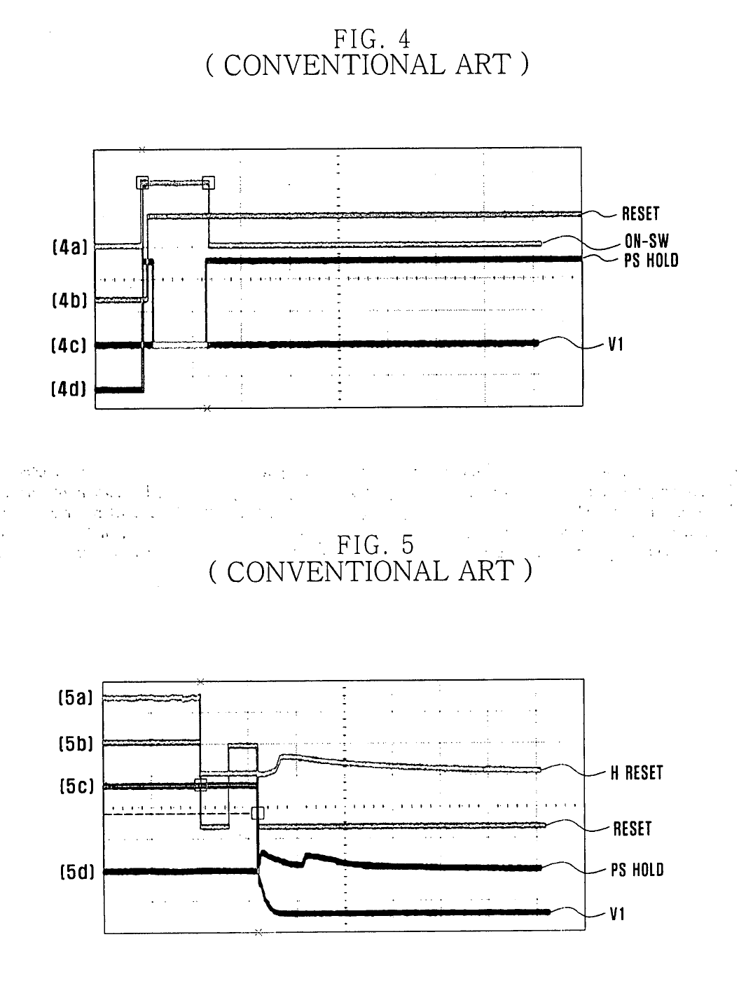

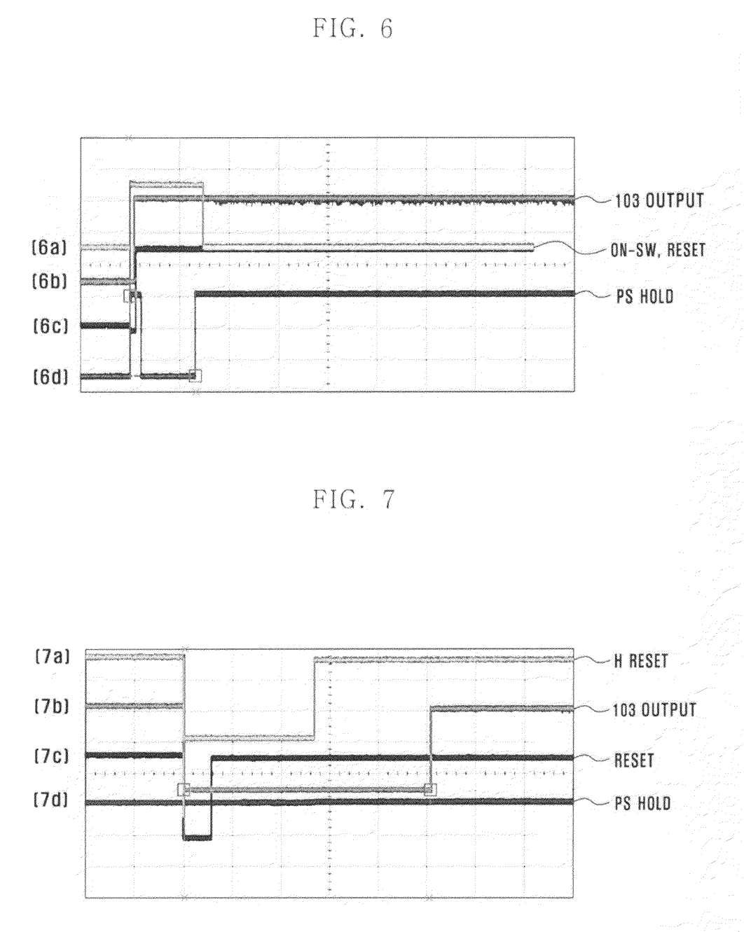

FIG. 2 is a flowchart illustrating a power on/off key triggered-reset procedure of a reset method according to an exemplary embodiment of the present invention. FIG. 3 is a flowchart illustrating a hardware reset key triggered-reset procedure of a reset method according to an exemplary embodiment of the present invention. FIG. 6 is a graph illustrating a reset timing of the reset method of FIG. 2, and FIG. 7 is a graph illustrating a reset timing of the reset method of FIG. 3.

Referring to FIGS. 2 and 6, the mobile phone commences in an off state (S201), and a power on/off key is input to turn on the mobile phone (S203). When the mobile phone is turned on, a signal 6a is supplied to the power controller 105 and the controller 109, and the power controller 105 outputs a reset signal 6c to the controller 105 through a reset terminal (RESET) such that the mobile phone is reset (S205). At this time, the output signal 6b of the hardware reset delay circuit 103 is preferably high. This is because a collector node of the transistor Q1 of the hardware reset signal generator 102 becomes high if the hardware reset key and the power status detector 101 are operating normally. The controller 109 determines whether the voltage applied to the GPIO is high (S207). If the voltage applied to the GPIO is high, the controller 109 recognizes an input of the power on/off key and determines whether the power on/off key is kept pressed for longer than a predetermined duration, such as 1.2 seconds (S209).

If the power on/off key is not kept pressed for longer than 1.2 seconds, the controller 109 maintains the mobile phone in a power-off state (S213).

If the power on/off key is pressed for longer than 1.2 seconds, the controller 109 outputs a power status maintenance signal (PS HOLD) 6d to the power controller 105 such that the power of the mobile phone is maintained in a power-on state (S211).

Referring to FIGS. 3 and 7, the transistor Q1 of the hardware reset signal generator 102 generates the hardware reset signal in two cases. First, when a voltage applied to the collector node of the transistor Q1 becomes low by pressing the hardware reset key while the mobile phone is turned on. Second, when the voltage applied to the collector node of the transistor Q1 becomes low by turning on the transistor Q1 according to the high output of the OR gate (OR1) due to an abnormality of the battery power.

In FIGS. 3 and 7, the mobile phone commences in an on state (S301). If the hardware reset key is pushed (S303), a ground voltage is applied to an emitter node of the transistor Q1 of the hardware reset signal generator 102 such that the transistor Q1 is turned on. Accordingly, a voltage of the collector node of the transistor Q1 becomes low, such that a hardware reset signal 7a is output to the hardware reset delay circuit 103 through an input node (MR) and the power controller 105 through a hardware reset terminal (nHRESET). The power controller 105 outputs a reset signal (RESET) 7c to the controller 109 according to a state transition of the hardware reset terminal (nHRESET).

That is, since the low voltage signal 7a is applied to the hardware reset terminal (nHRESET) of the power controller 105 and the input node (MR) of the hardware reset delay circuit 103 at the same time, the controller 109 initializes the mobile phone when the reset signal (RESET) 7c transits from low to high (S305). The hardware reset delay circuit 103 outputs a low signal 7b delayed for a predetermined time period (about 500 ms) required for rebooting the mobile phone and generated on the basis of the hardware reset signal 7a. The low signal 7b output from the hardware reset delay circuit 103 is provided to the controller 109 through the GPIO. The controller 109 determines whether the signal input through the GPIO is low (S307). If the signal input through the GPIO is low, the controller 109 regards the input signal as a hardware reset signal triggered by a hardware reset key manipulation and maintains the power status maintenance signal (PS HOLD) high regardless of a long key press.

The hardware reset delay circuit 103 maintains the low state of the GPIO long enough for the controller 109 to check. The hardware reset delay circuit can be modified by adjusting a time constant by adding a long timing reset circuit or resistors and capacitors at the output node.

Accordingly, the controller 109 determines that a power on/off key (ON-SW) is pushed when the input voltage at the GPIO is high, and a hardware reset key (H RESET) is pushed when the voltage at the GPIO is low.

When the power on/off key is input, the power condition is maintained after a long key press is applied. However, when the hardware reset key is input, the controller 109 initializes the mobile phone irrespective of a long key press and maintains the power condition. Accordingly, it is advantageously possible to initialize and reboot the mobile phone without removing the battery or pushing the power on/off key.

Although exemplary embodiments of the present invention are described in detail hereinabove, it should be clearly understood that many variations and modifications of the basic inventive concepts herein taught which may appear to those skilled in the present art will still fall within the spirit and scope of the present invention, as defined in the appended claims.

As described above, the reset circuit and method for a mobile phone according to exemplary embodiments of the present invention is advantageous in performing a hardware reset of the mobile phone without detaching a battery when the mobile phone is locked up or operates abnormally.

Also, the reset circuit and method for a mobile phone according to exemplary embodiments of the present invention maintain a power status of the mobile phone even after performing a hardware reset without removing the battery, resulting in improved user convenience.

What is claimed is:

1. A reset circuit of a mobile phone, comprising:
a hardware reset signal generator for generating a hardware reset signal in response to an input of a hardware reset key of the mobile phone;
a power controller for generating a reset signal on the basis of the hardware reset signal and controlling a power of the mobile phone according to a power status maintenance signal;
a controller that is initialized by the reset signal from the power controller, for generating the power status maintenance signal on the basis of a voltage level of the hardware reset signal; and
a hardware reset signal delay circuit for providing the hardware reset signal to the controller after delaying for a predetermined time duration.

2. The reset circuit of claim 1, wherein the hardware reset signal generator comprises a transistor for outputting the hardware reset signal to the hardware reset signal delay circuit and to the power controller.

3. The reset circuit of claim 1, further comprising a power supply status detector for detecting an abnormal power supply to the hardware reset signal generator.

4. The reset circuit of claim 3, wherein the power supply status detector comprises:
a power status detection unit for detecting an abnormal power status of the mobile phone; and
an OR gate for providing an output of the power status detection unit to the hardware reset signal generator.

5. The reset circuit of claim 1, wherein the hardware reset signal delay circuit can adjust a reboot time by adjusting the delay time duration of the hardware reset signal.

6. A reset method for a mobile phone, comprising:
inputting a reset signal for initializing the mobile phone;
initializing the mobile phone on the basis of the reset signal;
determining whether the reset signal is generated by a power on/off key or by a hardware reset key; and
maintaining power status of the mobile phone if the reset signal is triggered by the hardware reset key.

7. The reset method of claim 6, further comprising:
maintaining, if the reset signal is generated by the power on/off key and the power on/off key is pressed for a predetermined time duration, power status of the mobile phone; and
turning the power off if the reset signal is generated by the power on/off key and the power on/off key is pressed for less than the predetermined time duration.

8. A reset circuit of a mobile phone including a hardware reset key, a power on/off key, a controller having a GPIO and generating a power status maintenance signal, and a power controller receiving signal input by the hardware reset key and the power on/off key and the power status maintenance signal from the controller and providing a reset signal to the controller, comprising:
a power status monitor for detecting an abnormal power for operating the mobile phone;
a hardware reset signal generator for generating a hardware reset signal on the basis of an output of the power status monitor and the signal input by the hardware reset key; and
a hardware reset signal delay circuit for delaying the hardware reset signal for a predetermined time duration.

9. The reset circuit of claim 8, wherein the hardware reset generator comprises an NPN type transistor.

10. The reset circuit of claim 8, wherein an input node of the hardware reset signal delay circuit is connected to an output node of the power controller.

11. A computer readable medium of instructions for resetting a mobile phone comprising:
a first set of instructions adapted to input a reset signal for initializing the mobile phone;
a second set of instructions adapted to initialize the mobile phone on the basis of the reset signal;
a third set of instructions adapted to determine whether the reset signal is generated by a power on/off key or by a hardware reset key; and
a fourth set of instructions adapted to maintain power status of the mobile phone if the reset signal is triggered by the hardware reset key.

12. The computer readable medium of claim 11, further comprising:
a fifth set of instructions adapted to maintain power status of the mobile phone if the reset signal is generated by the power on/off key and the power on/off key is pressed for a predetermined time duration; and
a sixth set of instructions adapted to turn the power off if the reset signal is generated by the power on/off key and the power on/off key is pressed for less than the predetermined time duration.
